(19) United States
(12) Patent Application Publication
(10) Pub. No.: US 2025/0206242 A1
(43) Pub. Date: Jun. 26, 2025

(54) ELECTRIC VEHICLE

(71) Applicant: TOYOTA JIDOSHA KABUSHIKI KAISHA, Aichi-ken (JP)

(72) Inventor: Yoko ISHIGURO, Toyota-shi (JP)

(21) Appl. No.: 18/983,347

(22) Filed: Dec. 17, 2024

(30) Foreign Application Priority Data
Dec. 21, 2023 (JP) 2023-215417

(51) Int. Cl. B60R 16/02; B60R 7/04

(52) U.S. Cl. CPC B60R 16/0215; B60R 7/04

(57) ABSTRACT

An electric vehicle comprising: a high-voltage cable routed in a vehicle interior, a console box for accommodating the high-voltage cable; a console bracket for connecting the console box and an upper surface of a floor tunnel; and a metal cover disposed inside the console box and covering an upper portion of the high-voltage cable, wherein the metal cover is rotatably attached to the console bracket.

### CROSS REFERENCE TO RELATED APPLICATION

This application claims priority to Japanese Patent Application No. 2023-215417 filed on Dec. 21, 2023, which is incorporated herein by reference in its entirety including the specification, claims, drawings, and abstract.

### TECHNICAL FIELD

The present disclosure relates to a structure of an electric vehicle having a console box.

### BACKGROUND

A vehicle provided with a console box for placing small objects between front seats is used (see, for example, JP2010-18085A).

### SUMMARY

In recent years, a battery electric vehicle (hereinafter, referred to as a BEV) that runs by driving a motor with electric power from a battery charged by an external power source has been used. In such a BEV, a high-voltage cable that connects a battery and a high-voltage device may be disposed in the vehicle interior. In this case, it is required that the high-voltage cable is not exposed to the vehicle interior when the vehicle interior receives an impact force due to a collision or the like.

Accordingly, an object of the present disclosure is to suppress exposure of a high-voltage cable to a vehicle interior at the time of a collision in an electric vehicle in which the high-voltage cable is disposed in the vehicle interior.

An electric vehicle according to an embodiment of the present disclosure includes: a high-voltage cable routed in a vehicle interior; a console box for housing the high-voltage cable; a console bracket connecting the console box and an upper surface of a floor tunnel; and a metal cover disposed inside the console box and covering an upper portion of the high-voltage cable, wherein, the metal cover is rotatably attached to the console bracket.

As described above, since the high-voltage cable is covered with the metal cover, it is possible to prevent an external force from being applied to the high-voltage cable. Further, the metal cover rotates with respect to the console bracket when a large impact force is applied to the vehicle cabin in a collision. Accordingly, application of a large impact force to the metal cover is suppressed, and breakage of the metal cover is suppressed. Therefore, it is possible to prevent the high-voltage cable from being exposed to the vehicle interior due to breakage of the metal cover at the time of collision.

In the electric vehicle according to the present disclosure, the console box comprises: a body attached to the upper surface of the floor tunnel via the console bracket disposed therein, and a cable cover adjacent to a rear portion of the body and configured to accommodate the high-voltage cable therein, wherein the console bracket has a box shape and accommodates an inverter therein, the high-voltage cable is connected to a rear end of the inverter and extends from the rear end of the inverter toward a vehicle rear side above the floor tunnel, and the metal cover is disposed inside the cable cover and covers an upper portion of a connection portion between the inverter and the high-voltage cable and an upper portion of the high-voltage cable.

As described above, since the metal cover covers the upper portion of the connection portion between the inverter and the high-voltage cable and the upper portion of the high-voltage cable, it is possible to prevent an external force from being applied to the connection portion between the inverter and the high-voltage cable and the high-voltage cable. In addition, it is possible to prevent the connection portion between the inverter and the high-voltage cable and the high-voltage cable from being exposed to the vehicle interior at the time of collision.

In the electric vehicle according to the present disclosure, the metal cover and the console bracket are fastened to each other by one bolt.

Accordingly, since the metal cover cannot be removed unless the occupant uses the tool, it is possible to prevent the occupant from accidentally touching the connection portion between the inverter and the high-voltage cable or the high-voltage cable.

According to the present disclosure, in an electric vehicle in which a high-voltage cable is disposed in a vehicle interior, exposure of the high-voltage cable to the vehicle interior at the time of a collision can be suppressed.

### BRIEF DESCRIPTION OF DRAWINGS

FIG. 1 is a perspective view of a vehicle cabin of an electric vehicle according to an embodiment;

FIG. 2 is an exploded perspective view showing a console box, a console bracket, an inverter, a high-voltage cable, and a metal cover shown in FIG. 1;

FIG. 3 is an enlarged perspective view showing a fastening portion between a console bracket and a metal cover;

FIG. 4 is a cross-sectional view of a portion A shown in FIG. 1;

FIG. 5 is a perspective view showing movement and deformation of the console bracket and the metal cover when the electric vehicle has a side collision.

### DESCRIPTION OF EMBODIMENTS

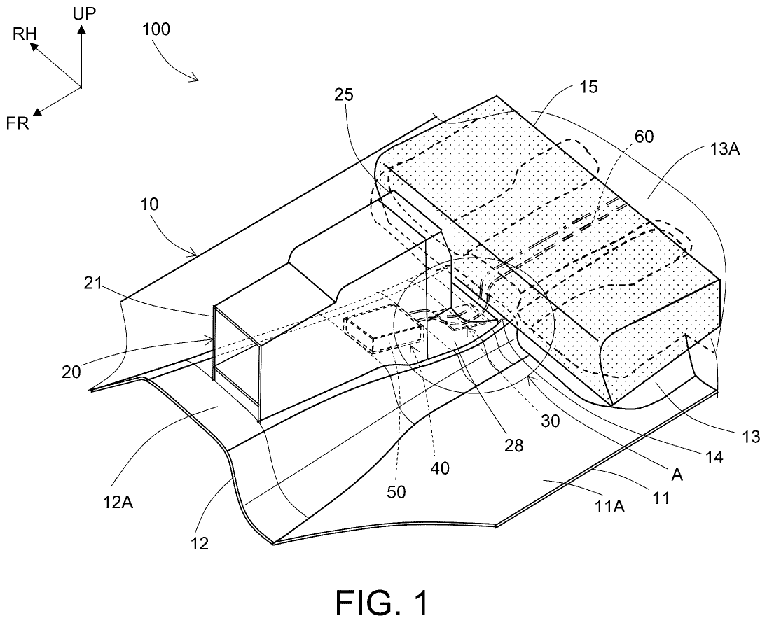

Hereinafter, an electric vehicle 100 according to an embodiment will be described with reference to the drawings. Although the electric vehicle 100 is described as a BEV, it may be a hybrid electric vehicle that runs by an engine and a motor. As shown in FIG. 1, the electric vehicle 100 includes a vehicle cabin 10, a console box 20, a console bracket 40, an inverter 50, a metal cover 30, and a high-voltage cable 60. Note that FR, UP, and RH shown in the drawings indicate a front side, an upper side, and a right side of the electric vehicle 100, respectively. The opposite directions of FR, UP, and RH indicate the rear side, the lower side, and the left side, respectively. Hereinafter, in the case where the front-rear direction, the left-right direction, and the up-down direction are simply used, the front-rear direction, the left-right direction, and the up-down direction of the electric vehicle 100 are indicated unless otherwise specified.

The vehicle cabin 10 includes a floor panel 11, a floor tunnel 12, and a rear floor panel 13. The floor panel 11 is a plate member that forms a floor of the vehicle cabin 10. The floor tunnel 12 is a portion that is disposed in a central portion of the vehicle cabin 10 in the vehicle width direction and protrudes upward from the upper surface 11A of the floor panel 11. The floor tunnel 12 has a groove-shaped cross section opened downward, and extends toward the rear of the vehicle from a dash panel (not shown) in front of the vehicle cabin to the front of the rear floor panel 13. The rear floor panel 13 is a pedestal-shaped portion that rises upward from the floor panel 11 behind the floor tunnel 12. Left and right front seats (not shown) are mounted on the floor panel 11 on both sides of the floor tunnel 12. A rear seat 15 is attached above the rear floor panel 13. A region above the upper surface 11A of the floor panel 11, a region above the upper surface 12A of the floor tunnel 12, and a region above the upper surface 13A of the rear floor panel 13 constitute a region in the vehicle interior.

A console box 20 is mounted on the floor tunnel 12. The console box 20 is an interior component that accommodates small items therein. The console box 20 includes a main body 21, an end panel 25, and a cable cover 28. As will be described later, the main body 21 is attached to the upper surface 12A of the floor tunnel 12 via a console bracket 40 disposed therein. An inverter 50 is mounted inside the console bracket 40. A high-voltage cable 60 is connected to the inverter 50. The high-voltage cable 60 is housed inside the cable cover 28 and extends from the inverter 50 toward the rear of the vehicle. A floor trim 14 is attached between the cable cover 28 and the rear floor panel 13.

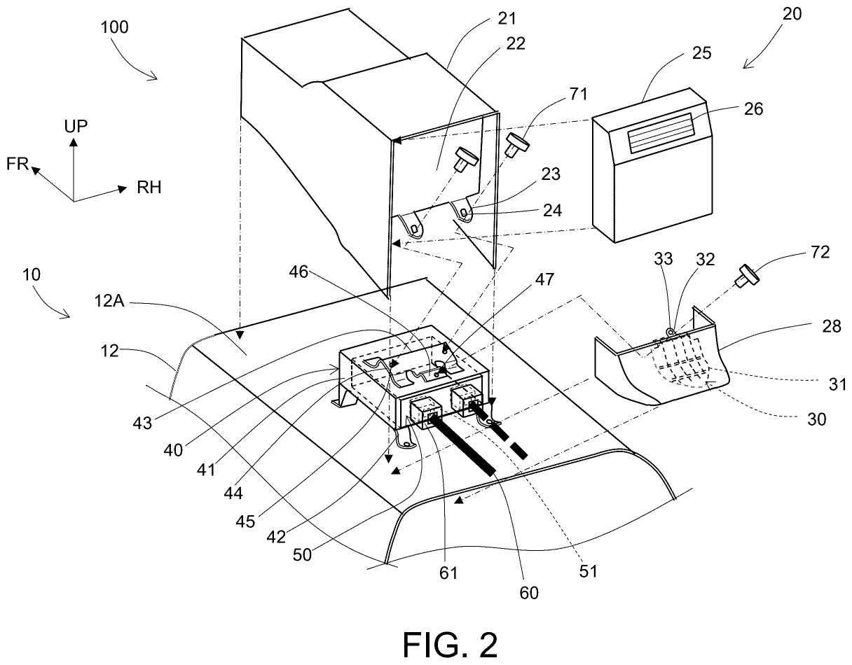

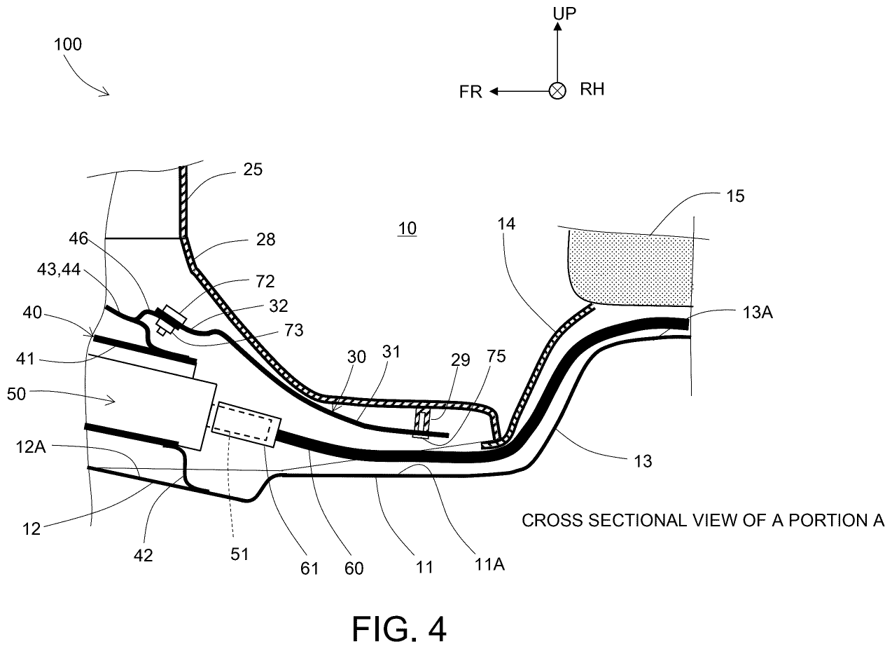

As shown in FIG. 2, the console bracket 40 is made of metal and includes a housing 41, a lower bracket 42, and an upper bracket 43. The housing 41 has a rectangular box-like shape that is open in the front-rear direction. An inverter 50 is attached to the bottom surface inside the housing 41. The lower bracket 42 is a leg portion that is attached to the lower surfaces of the front end and the rear end of the housing 41 and extends downward. The lower bracket 42 is attached to the upper surface 12A of the floor tunnel 12 by a fastening member such as a bolt. The upper bracket 43 is attached to the upper surface of the housing 41. The upper bracket 43 includes a pedestal portion 44 to which the main body 21 of the console box 20 is fastened and a tongue portion 46 to which the metal cover 30 is fastened. The pedestal portion 44 has a hat-shaped cross section convex upward, and a screw hole 45 is provided in the web. The tongue portion 46 is a plate member that extends in a crank shape toward the vehicle rear side at the vehicle width direction central portion of the pedestal portion 44. The tongue portion 46 is provided with a bolt hole 47. A fixing nut 73 is provided on the lower surface of the tongue portion 46 (see FIG. 4).

The inverter 50 attached to the housing 41 is provided with a connection terminal 51 at its rear end. The connector 61 of the high-voltage cable 60 is connected to the connection terminal 51. The high-voltage cable 60 extends from the rear end of the inverter 50 toward the rear of the vehicle above the floor tunnel 12. In this way, the high-voltage cable 60 is routed in the vehicle interior. Here, the connection terminal 51 and the connector 61 constitute a connection portion between the inverter 50 and the high-voltage cable 60.

As described above, the console box 20 includes the main body 21, the end panel 25, and the cable cover 28. The main body 21 is attached to the upper surface 12A of the floor tunnel 12. The main body 21 is made of resin and includes a box portion 22 that accommodates small objects. An arm portion 23 extending obliquely downward is provided at the rear end of the box portion 22. The arm portion 23 is provided with a bolt hole 24.

The end panel 25 is a member attached to an upper portion of a rear end of the main body 21. The end panel 25 is made of resin and is provided with a blowout port 26 that blows out the conditioned air toward the rear. The cable cover 28 is made of resin, and is disposed adjacent to the main body 21 at a lower portion on the rear side of the main body 21.

The metal cover 30 includes a plate-shaped portion 31 and a fastening portion 32 protruding from the plate-shaped portion 31 toward the front of the vehicle. The fastening portion 32 is provided with a bolt hole 33. As shown in FIG. 4, the metal cover 30 is attached to the inner surface of the cable cover 28. A pin seat 29 is provided on the inner surface of the cable cover 28. The metal cover 30 is attached to the inner surface of the cable cover 28 by pins 75.

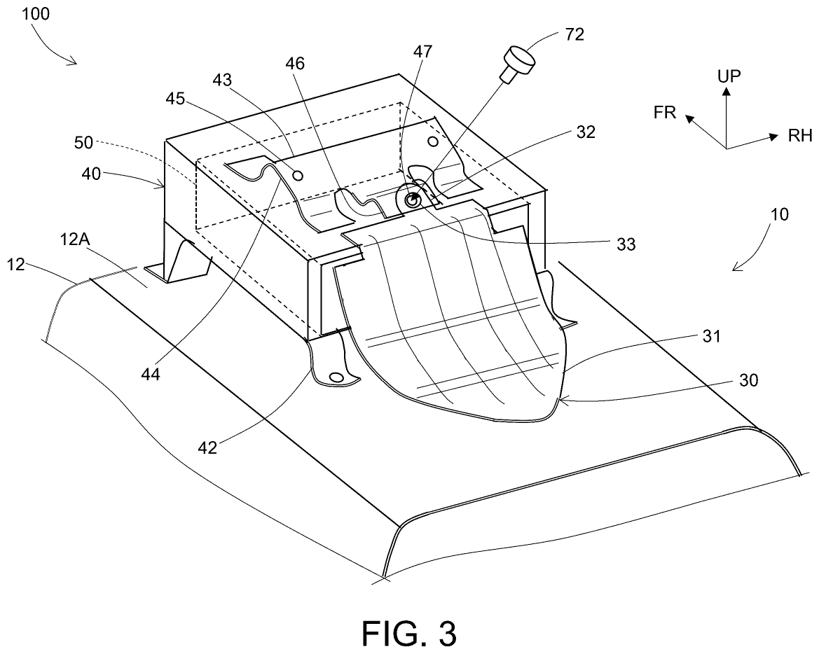

Next, an assembly procedure of the console box 20 will be described with reference to FIGS. 2 and 3. First, as shown in FIG. 2, the bolt hole 24 of the arm portion 23 of the main body 21 is fitted into the screw hole 45 provided in the pedestal portion 44 of the console bracket 40. Then, the arm portion 23 is fixed on the pedestal portion 44 by the bolt 71. Thus, the console bracket 40 connects the main body 21 and the upper surface 12A of the floor tunnel 12.

The cable cover 28 is then connected to the rear end of the main body 21 and above the floor tunnel 12. As a result, the position of the bolt hole 33 of the fastening portion 32 of the metal cover 30 and the position of the bolt hole 47 of the tongue portion 46 of the console bracket 40 coincide with each other. A bolt 72 is passed through the bolt hole 47 and 33, and the bolt 72 is screwed into a fixing nut 73 (see FIG. 4) to fasten the fastening portion 32 to the tongue portion 46.

Next, the front end of the end panel 25 is connected to the rear end of the main body 21, and the lower end of the end panel 25 is connected to the upper end of the cable cover 28.

In this way, the main body 21 is attached to the upper surface 12A of the floor tunnel 12 via the console bracket 40 disposed therein. Since the inverter 50 is attached to the inside of the console bracket 40, when the main body 21 is attached to the floor tunnel 12, the inverter 50 is accommodated in the main body 21. As shown in FIG. 4, when the cable cover 28 is mounted on the floor tunnel 12, the high-voltage cable 60, the connector 61, and the connection terminal 51 are accommodated in the cable cover 28. The metal cover 30 covers the high-voltage cable 60, the connector 61, and the connection terminal 51 from above. Accordingly, the metal cover 30 covers the high-voltage cable 60 and the connection portion between the inverter 50 and the high-voltage cable 60 from above. Further, since the metal cover 30 is fastened to the console bracket 40 by one bolt 72, the metal cover 30 is rotatable around the bolt 72 when a large force is applied thereto. The tightening torque of the bolt 72 may be managed so that the metal cover 30 can rotate when a large force is applied.

As shown in FIG. 4, the high-voltage cable 60 extends toward the vehicle rear side above the floor tunnel 12, and extends toward the vehicle rear side from the rear end of the cable cover 28. The high-voltage cable 60 passes between the floor panel 11 and the floor trim 14 and extends upward from the front surface of the rear floor panel 13 toward the upper surface 13A of the rear floor panel 13. The high-voltage cable 60 extends toward the rear of the vehicle between the upper surface 13A of the rear floor panel 13 and the rear seat 15.

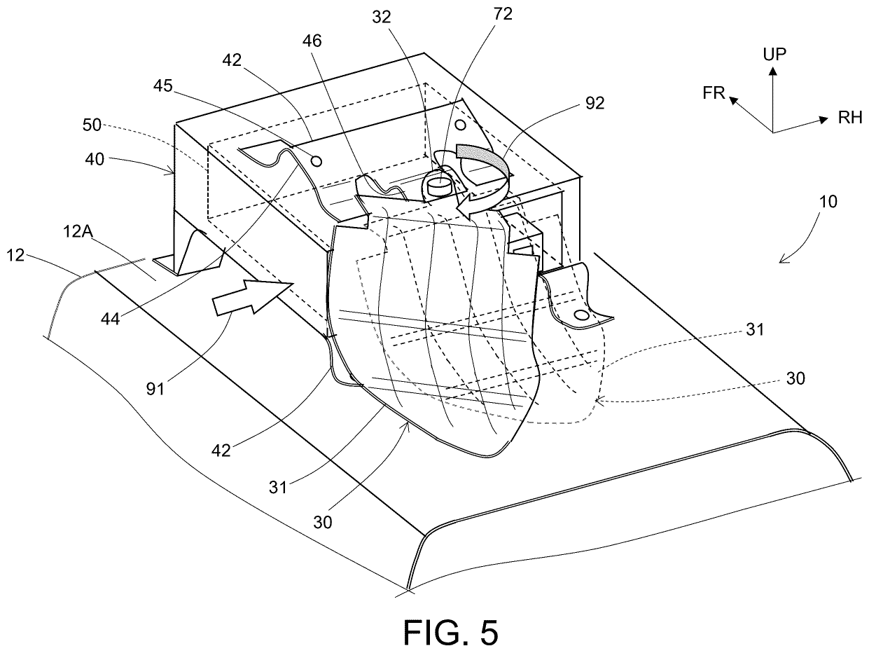

Next, the movement and deformation of each part at the time of a side collision of the electric vehicle 100 will be described with reference to FIG. 5. As indicated by an outlined arrow 91 in FIG. 5, when an impact force is input from the left side of the vehicle due to a side collision, the floor tunnel 12 deforms or moves rightward. As a result, the console bracket 40 moves or deforms in the right direction. At this time, the fastening portion 32 of the metal cover 30 moves to the right together with the console bracket 40. The fastening portion 32 is fastened to the tongue portion 46 by one bolt 72. Therefore, when receiving a large impact force, the fastening portion 32 rotates around the bolt 72 as indicated by a white arrow 92 in FIG. 5. Accordingly, application of a large impact force to the metal cover 30 can be suppressed, and breakage of the metal cover 30 can be suppressed. Accordingly, it is possible to prevent the high-voltage cable 60 disposed in the vehicle interior from being exposed to the vehicle interior due to breakage of the metal cover 30 at the time of a side collision.

As described above, since the electric vehicle 100 covers the high-voltage cable 60 disposed in the vehicle interior with the metal cover 30, it is possible to prevent an external force from being applied to the high-voltage cable 60. In addition, at the time of collision, the metal cover 30 is prevented from being broken due to impact force caused by rotation of the metal cover 30 with respect to the console bracket 40, and the high-voltage cable 60 can be prevented from being exposed to the vehicle interior.

In addition, in the electric vehicle 100, since the metal cover 30 covers the upper side of the connection portion between the inverter 50 and the high-voltage cable 60 and the upper side of the high-voltage cable 60, it is possible to prevent an external force from being applied to the connection portion between the inverter 50 and the high-voltage cable 60 and the high-voltage cable 60. In addition, it is possible to prevent the connection portion between the inverter 50 and the high-voltage cable 60 and the high-voltage cable 60 from being exposed to the vehicle interior at the time of collision.

In addition, in the electric vehicle 100, since the cable cover 28, the floor trim 14, and the rear seat 15 cover the high-voltage cable 60 from above, it is possible to suppress the high-voltage cable 60 disposed in the vehicle interior from being exposed to the vehicle interior.

Further, in the electric vehicle 100, since the metal cover 30 and the console bracket 40 are fastened to each other by the bolt 72, the metal cover 30 cannot be removed unless the occupant uses a tool. Therefore, it is possible to prevent the occupant from accidentally touching the connection portion between the inverter 50 and the high-voltage cable 60 or the high-voltage cable 60 disposed in the vehicle interior.

1. An electric vehicle comprising:
a high-voltage cable routed in a vehicle interior;
a console box for housing the high-voltage cable;
a console bracket connecting the console box and an upper surface of a floor tunnel; and
a metal cover disposed inside the console box and covering an upper portion of the high-voltage cable, wherein
the metal cover is rotatably attached to the console bracket.

2. The electric vehicle according to claim 1, wherein
the console box comprises:
a body attached to the upper surface of the floor tunnel via the console bracket disposed therein, and
a cable cover adjacent to a rear portion of the body and configured to accommodate the high-voltage cable therein,
wherein the console bracket has a box shape and accommodates an inverter therein,
the high-voltage cable is connected to a rear end of the inverter and extends from the rear end of the inverter toward a vehicle rear side above the floor tunnel, and
the metal cover is disposed inside the cable cover and covers an upper portion of a connection portion between the inverter and the high-voltage cable and an upper portion of the high-voltage cable.

3. The electric vehicle according to claim 1, wherein
the metal cover and the console bracket are fastened by one bolt.

4. The electric vehicle according to claim 2, wherein
the metal cover and the console bracket are fastened by one bolt.
